(19) United States
(12) Patent Application Publication
(10) Pub. No.: US 2011/0283014 A1
(43) Pub. Date: Nov. 17, 2011

(54) Distribution of Multimedia Content over a Network

(76) Inventors: Rahul Malik, Bangalore (IN); Meghna Agrawal, Bangalore (IN)

(21) Appl. No.: 12/780,120

(22) Filed: May 14, 2010

(51) Int. Cl. G06F 15/16

(52) U.S. Cl. 709/233; 709/234

(57) ABSTRACT

Performing transmission of data over network using at least a first and second rate adaptation algorithm. The transmission of data may use a plurality of buffers. It may be determined that a number of available buffers of the plurality of buffers is below a first threshold. Accordingly, data may be transmitted according to the second rate adaptation algorithm which provides increased flowrate. During the transmission of the data, it may be determined that the number of available buffers of the plurality of buffers exceeds a second threshold. Accordingly, data may be transmitted according to the first rate adaptation algorithm that provides increased throughput.

### FIELD OF THE INVENTION

The present invention relates generally to network communication, and more particularly to methods for distribution of multimedia content.

### DESCRIPTION OF THE RELATED ART

Driven by the increasing prevalence of digital content, data and multi-media applications, of late there has been a dramatic growth in the need for networking—originating from its traditional use of providing connectivity between computers and printers in the enterprise and its spread to the home, to the emergence of new applications that rely on network connectivity.

Unlike enterprise networks, where switched Ethernet technology is deployed over dedicated CAT5/CAT6 cabling, in order to keep installation deployment costs low, home local area networking (LAN) technologies are designed for operation over existing media within the home. Wired LANs use one or a combination of existing power-line, phone-line or coaxial cable plants in the home, while wireless LANs (WLANs) use the ubiquitous wireless medium. Thus, home networking LANs tend to be shared medium communication networks.

Additionally, as the media was not designed/provisioned solely for the LAN communications, there are several channel impairments—e.g.: in the case of power-line networks, other power-line devices may operate in a manner that interferes with LAN-communications; while in a WLAN, impairments may range from—extraneous interference due to other WLANs and other devices in the same radio band; to channel fading and shadowing, among others.

As a result of the variation in the characteristics of the channel the achievable data rate to different locations within the home is not a constant. It is often modeled as a random function varying with time.

To ensure communications over a channel with time-varying capacity and characteristics, the medium access control (MAC) protocols of variable transmission rate LAN technologies typically have ‘rate-selection/adaptation’ functionality to determine the optimal combination of physical-layer (PHY) parameters to use for a particular communication. The rate-adaptation algorithm is designed to typically optimize a target function—such as maximizing throughput between a source and a sink.

Apart from the traditional application of providing internet connectivity to multiple computers within the home, an emerging application for home LANs is the transport and serving of audio/video content to one or more rendering devices within the home. Within the home, content may originate from multiple sources—such as a digital video recorder (DVR) or a digital video disc (DVD) player, among other content sources. The content may also originate from outside the home—for example in the case of internet protocol television (IPTV), the content originates from a head-end server outside the home and reaches the home via the carrier's wide area network (WAN) infrastructure, entering the home through a broad-band access modem or a residential gateway. Broadcast media may be received via cable or satellite receiver within the home. Content may be viewed/rendered on different content sink devices such as—flat panel displays, laptop computers and portable media-player devices, among others. Within the home, content sources and content sinks may be placed in different rooms, at the discretion of users within the home.

The overall goal of the LAN system design is to provide quality of service (QoS) which translates to minimal disruption to the user's listening/viewing experience caused by a loss/delay of packets. Accordingly, improvements in network data transmissions are desired.

### SUMMARY OF THE INVENTION

Various embodiments are presented of a system and method for distribution of content over a network.

Data (e.g., multimedia data, including audio/video data) may be transmitted from a first device to a second device (or a plurality of devices) using a selected rate adaptation algorithm. The selected rate adaptation algorithm may be a first rate adaptation algorithm or a second rate adaptation algorithm (or one or more additional rate adaptation algorithms). The data may be generated or received from a content generator and may be stored in one or more buffers (e.g., a plurality of buffers) for transmission. Note that the data may be generated at a rate that is independent of a rate of transmission from the first device to the second device.

In one embodiment, the number of available buffers (or the amount of memory available in the buffers) may determine which rate adaptation algorithm is used. More specifically, in one embodiment, the number of available buffers may be used to determine when to switch from one rate adaptation algorithm to another.

In one embodiment, the first threshold may be used to determine when to switch from the first rate adaptation algorithm. Thus, the second rate adaptation algorithm may be used when the plurality of available buffers is below a first threshold. The second rate adaptation algorithm may provide increased flowrate, i.e., it may attempt to maximize flowrate. Flowrate may be defined as:

F_{a,b,j}=rⱼ*η_{a,b,j}*(1−PER_{a,b,j})*N_{a,b,j}

where ‘η_{a,b,j}’ is the efficiency when transmitting from the first device (a) to the second device (‘b’) at rate ‘rⱼ’, where ‘PER_{a,b,j}’ is the probability of error (PER) of the channel from ‘a’ to ‘b’ for rate ‘rⱼ’, and where ‘N_{a,b,j}’ is the maximum number of transmission attempts allowed for the flow from ‘a’ to ‘b’ at rate ‘rⱼ’.

In one embodiment, a second threshold may be used to determine when to switch from the second rate adaptation algorithm to the first. Thus, when operating using a second rate adaptation algorithm, the first rate adaptation algorithm may be used when the plurality of available buffers is above the second threshold. The first rate adaptation algorithm may provide increased throughput, i.e., it may attempt to maximize throughput. Throughput may be defined as:

T_{a,b,i}=rᵢ*η_{a,b,i}*(1−PER_{a,b,i})

where η_{a,b,i} is the efficiency when transmitting from the first device (a) to the second device (‘b’) at rate ‘rᵢ’, and where PER_{a,b,i} is the probability of error (PER) of the channel from ‘a’ to ‘b’ for rate ‘rᵢ’.

Note that the first and second thresholds may be the same value; however, these thresholds may also be different, e.g., in order to avoid constant switching between the two algorithms when the number of available buffers is near the threshold. Additionally, in some embodiments, the first threshold and/or the second threshold may be dynamically adjusted during run time (e.g., while data is being transferred). Such adjustments may be based on the size of the plurality of buffers, the current output data-rate, and/or an effective transmission rate. Alternatively, or additionally, the adjusting may be performed based on an expected length of sequence of high priority packets of the data and/or burstiness of said transmitting the data.

### BRIEF DESCRIPTION OF THE DRAWINGS

A better understanding of the present invention can be obtained when the following detailed description of the preferred embodiment is considered in conjunction with the following drawings, in which:

FIG. 1 illustrates exemplary devices performing communication in a home network, according to one embodiment;

FIG. 2 is an exemplary block diagram of a first device transmitting information to a second device, according to one embodiment;

FIG. 3 is a state diagram illustrating different states of a transmitting device

FIG. 4 is a flowchart diagram illustrating one embodiment of a transmission method using multi-state rate adaptation; and

FIG. 5 is a block diagram of an exemplary source device transmitting data to a sink device according to some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

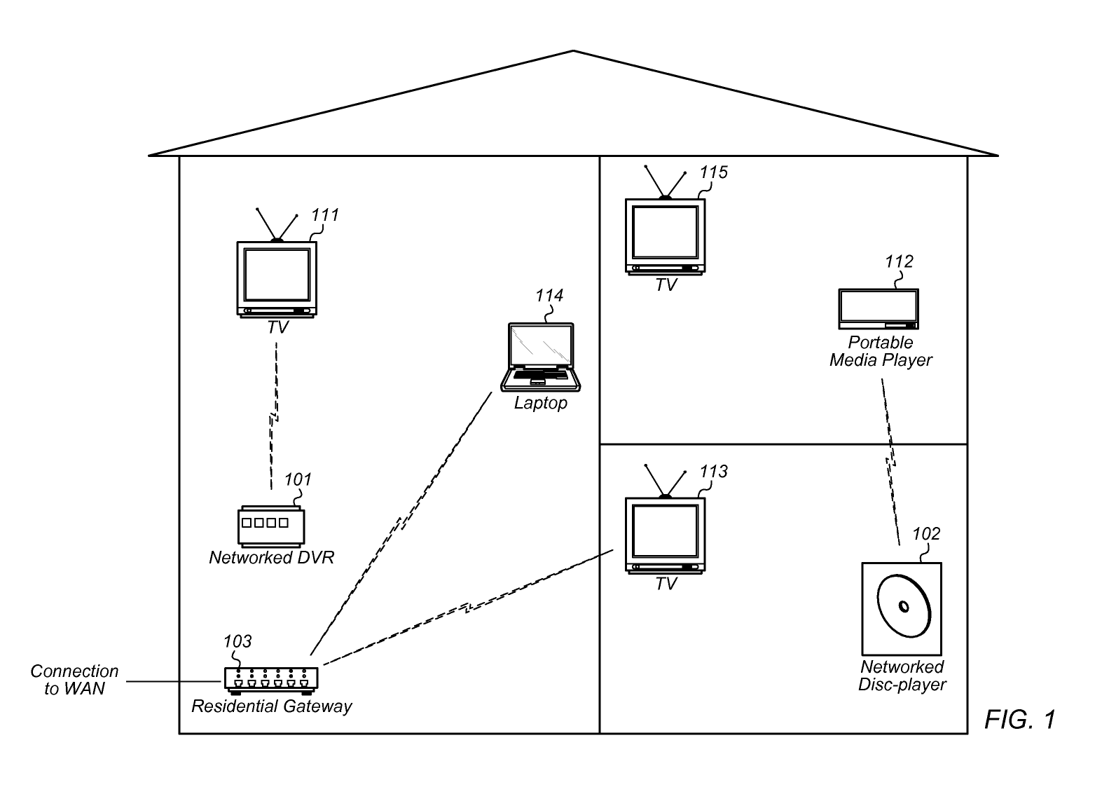

### FIG. 1—Exemplary Home Network

FIG. 1 is exemplary of a home network which may implement embodiments of the invention. As shown, the home network may employ WLAN as the under-lying LAN technology, although wired LAN is also envisioned. 101 represents a networked digital video recorder (DVR) streaming content to a television set 111. 102 represents a networked disc-player that is streaming audio content to a portable media player 112 being used in another room in the home. 113 represents a television set that is rendering IPTV content received over the WAN by the residential gateway 103. 114 is a laptop-computer surfing the internet via the residential gateway 103.

Depending on usage at any time, it would be apparent that any sink device may connect to any source device—e.g., TV 115 may establish a connection to 103 to receive content. Likewise, some devices may be capable of acting as both source and sink. For example, laptop 114 may act as a source device for TV 115. Further, it would be apparent that FIG. 1 depicts the data flow between source and sink in a typical usage scenario. The actual deployment may require additional infrastructure in the form of wireless access-points and repeaters, to name a few. It would also be apparent that the functionality of this infrastructure may be embedded in one or more devices as depicted in FIG. 1.

As described in the background section, the channel capacity of the links between the source and sink may vary with time, depending on various factors—distance between source and sink, channel occupancy by other devices, interference from extraneous sources (e.g., both within and outside the home). In the case of the WLAN depicted in FIG. 1, the channel conditions may also depend on the relative motion of source, sink and in the surrounding environment.

Depending on the permutation of the various transmission parameters of the LAN PHY-layer, the MAC-layer may use a rate adaptation strategy that selects a transmission rate to be used for transmitting data to a particular destination from an available rate-set. For data communications, one strategy maximizes throughput of the link, as described in the following:

For a transmission from node ‘a’ to ‘b’, the selected rate ‘r’ drawn from the set of rates ‘R’, having ‘i’ elements, is the rate that maximizes the throughput T_{a,b,i} for all ‘i’ as shown in equation (1):

T_{a,b,i}=rᵢ*η_{a,b,i}*(1−PER_{a,b,i}) (1)

Where, η_{a,b,i} is the efficiency of the MAC when transmitting from ‘a’ to ‘b’ at rate ‘rᵢ’; and PER_{a,b,i} is the probability of error (PER) of the channel from ‘a’ to ‘b’ for rate ‘rᵢ’.

Packets that fail transmission may be retransmitted up to a protocol-specific limit on number of retries.

The rate adaptation strategy of maximizing network throughput may be particularly suited for data traffic as it ensures optimal usage of network resources. The usage of the transmission control protocol (TCP) at the upper-layer ensures error-recovery and flow control above layer-2.

However, audio/video traffic, in addition to having high data rates, is highly latency sensitive and requires reception in real time. In order to cater to the tight latency requirements, and the fact that audio/video traffic may often be broadcast/multicast content requiring delivery to multiple content sinks, the universal datagram protocol (UDP) may be employed. Unlike TCP, UDP does not offer flow-control or error-recovery.

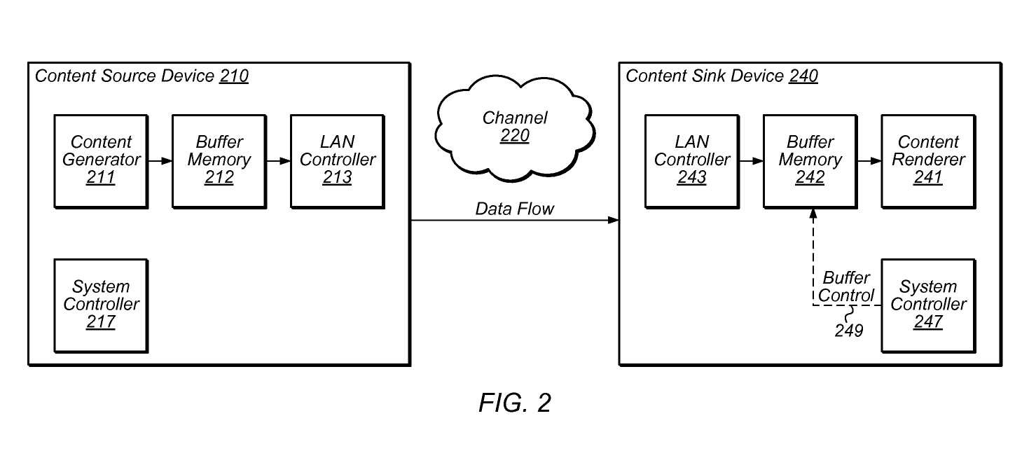

### FIG. 2—Exemplary Behavioral Model of a Content Device and a Sink Device

FIG. 2 represents an exemplary behavioral model of a content source device 210 and a content sink device 240 as per a realization of the entities in FIG. 1.

The content source device may include a content generator 211 that outputs packetized audio/video and control data to a LAN controller 213 that transmits the packetized data on the channel 220, in accordance with the MAC and PHY layer protocols of the LAN. Buffer memory 212 may interface the content generator 211 to the LAN controller 213. System controller 217 may control the operation of the various functional modules of 210.

The content sink device 240 may include a content rendering module 241 that may receive packetized audio and/or video from the LAN controller 243 and may output the data it in a user recognizable form, e.g., as images, such as video, and/or sound, e.g., from a television set. Buffer memory 242 may interface the LAN controller 243 to the content rendering module 241. System controller 247 may control the operation of the various functional modules of 240.

Buffer memories 212 and 242 in the content source 210 and content sink 240, respectively, may help maintain quality of service (QoS) of the transmitted video stream in the presence of possible variations in output rate of the content generator 211, variations in the channel capacity 220, and variations in the output rate of the content rendering module 241.

For instance, in the event of a channel 220 outage for a brief duration, buffer 212 absorbs the excess data generated by content generator 211 that cannot be successfully transmitted by LAN controller 213. Likewise, buffer 242 outputs previously received and stored data to content rendering module 241, thereby ensuring continuity of content and consequently QoS to the user. The depths of buffers 212 and 242 determine the duration of the channel outage that can be tolerated and the response-time latency of the system—both conflicting requirements in terms of providing QoS to the user.

In the example of IPTV delivery where the content source device 210 represents the broadband gateway, the content generator 211 (e.g., within the broadband gateway) is dependant on the head-end server in the WAN for generating packetized data for transmission by the LAN controller 213. Buffer 212 may help absorb any outage or delay in the WAN that prevents the content generator from generating content for transmission.

As discussed previously, with the use of the UDP protocol (or similar protocols) for audio-video traffic there is no flow-control and error recovery at the transport-layer. Layer-2 flow control and error recovery as provided by the underlying LAN technology is limited to the link between LAN controllers 213 and 243 of FIG. 2.

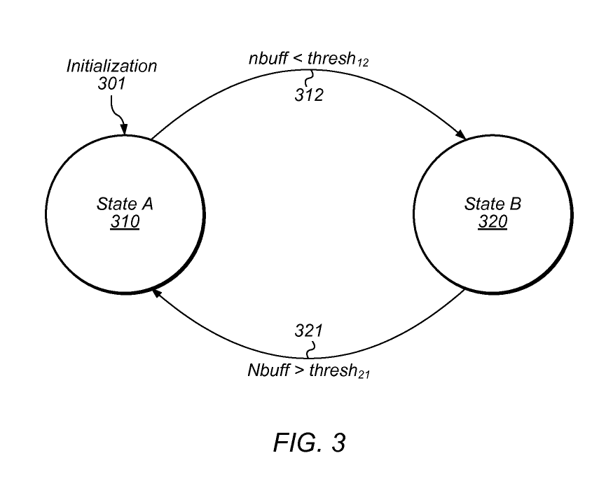

### FIG. 3—Multi-State Rate Adaptation

Embodiments described herein provide for video distribution that facilitates improved QoS and a better user-experience in terms of multimedia content streamed over a network operating on a time varying channel. In the following, various embodiments may be explained with respect to the example of a Wireless LAN in a home environment. However, these embodiments may be equally applicable to any networking technology operating over a time varying channel, and, by the same token, the present invention may not be constrained to the environment of operation.

By virtue of the fact that content is often live (as in IPTV or broadcast TV for example), or multicast/broadcast to multiple end-points that require synchronized output (such as networked speakers, displays); or that the feedback latency is often too high, the content generator 211 may generate content at a rate that is independent of the condition of the underlying channel 220.

As a result of adverse conditions on the wireless channel 220, the channel capacity may decrease, e.g., while transferring data. Consequently, the rate adaptation algorithm as part of LAN controller 213 may drop the allowed transmission rate to one that is below the output data rate of Content Generator 211. When buffer memory 212 is full, this may result in a loss of data.

In one embodiment, the LAN controller 213 uses a multi-state rate adaptation approach, depending on the output data rate of content generator, the amount of available memory in the buffer and the effective transmission rate achievable by LAN controller 213, as described in the following.

FIG. 3 is a state machine representation of an exemplary rate control algorithm having two states, as per the present embodiments. Note that various embodiments described herein may refer to each state having a separate rate adaptation algorithm, rather than a single algorithm with different states. At system initialization, the rate adaptation algorithm may begin in ‘stateA’ 310 via path 301 (“first rate adaptation algorithm”). However, the algorithm may transition to ‘stateB’ 320 via path 312 (“second rate adaptation algorithm”), when the number of available buffers in 212 falls below ‘thresh₁₂’ (“first threshold”). Transition from ‘stateB’ 320 to ‘stateA’ 310 may be via path 321, when the number of available buffers in buffer memory 212 exceeds ‘thresh₂₁’ (“second threshold”). ‘thresh₁₂’ and ‘thresh₂₁’ may be determined dynamically, at run time.

In some embodiments, these thresholds may be functions of the size of the buffer memory 212, the output data-rate of the content generator 211, and the effective transmission rate of the LAN controller 213, as described subsequently. The state machine of FIG. 3 may be realized by means of software and/or hardware implementation on content source device 210, specifically residing within LAN controller 213 of FIG. 2, as desired.

In one embodiment, when operating in ‘stateA’ 310, the LAN controller 213 may adopt a rate adaptation strategy that attempts to maximize the effective throughput of the link, e.g., it may attempt to satisfy the criteria stated in equation (1). Thus, when the channel conditions result in errors in a transmission, the rate adaptation strategy results in the LAN controller 213 attempting to retransmit the packet using the transmission rate rᵢ that maximizes the throughput T_{a,b,i} until the packet is successfully transmitted or the packet is dropped at the transmitter due to a protocol/implementation specific limit on the number of transmission attempts being reached.

Embodiments described herein take into account that a packet-error as seen by LAN controller 213 is recoverable from in that a retransmission may be attempted, while a packet-loss say, due to over-flow at buffer memory 212 is not. Further, it is recognized that audio/video packets are useful to the content sink device 240, only if received within a latency bound, after which they may be dropped and are consequently not rendered by content renderer 241. The transmission of such packets constitutes a waste of transmission resources/channel capacity as their reception by 240 has no consequence on the QoS. Moreover, the channel capacity that was used for such transmission could have been otherwise used to transmit packets that did have bearing on the QoS.

It is further recognized that based on the typical statistics of channel outage duration, the QoS as perceived by the end-user is impacted by the ‘duration of discontinuity of packets’—defined as the period of time or the length of a sequence between the first lost packet and the last lost packet in a content stream.

It is still further recognized that when buffer 212 overflows, attempts to transmit packets stored in the buffer can result in additional drops due to buffer-overflow at the tail of the buffer, the transmission of packets in the buffer resulting in an increase in duration of discontinuity of packets and such transmitted packets likely exceeding the latency-bound of the packet, resulting in eventual drops at the receiver, effectively decreasing the QoS.

Based on the collective findings described above, as per one embodiment, when operating in ‘stateB’ 320, LAN controller 213 may adopt a rate adaptation strategy with the target of maximizing flow-rate, as described in the following:

For a transmission from node ‘a’ to ‘b’, the selected rate ‘r’ drawn from the subset of rates ‘R′’, having ‘j’ elements, is the rate that maximizes the flow-rate F_{a,b,j} for all ‘j’ is shown in equation (2):

F_{a,b,j}=rⱼ*η_{a,b,j}*(1−PER_{a,b,j})*N_{a,b,j} (2)

Where, ‘η_{a,b,j}’ is the efficiency of the MAC when transmitting from ‘a’ to ‘b’ at rate ‘rⱼ’; ‘PER_{a,b,j}’ is the probability of error (PER) of the channel from ‘a’ to ‘b’ for rate ‘rⱼ’; ‘N_{a,b,j}’ is the maximum number of transmission attempts allowed for the flow from ‘a’ to ‘b’ at rate ‘rⱼ’; and ‘R′’ is the subset of ‘R’ that contains T elements ‘rⱼ’ that satisfy the condition of equation (3):

rⱼ*η_{a,b,j}≧I (3)

Where, ‘I’ is the ingress rate or the offered load from the content generator 211.

In one embodiment, ‘N_{a,b,j}’ may be computed as per equation (4a):

N_{a,b,j}=[rⱼ*η_{a,b,j}*(1−μ)]/I (4a)

Alternatively, N_{a,b,j} may be computed as per equation (4b):

N_{a,b,j}=floor([rⱼ*η_{a,b,j}*(1−μ]/I) (4b)

Where, ‘μ’ is the medium utilization for all transmissions on the channel other than from node ‘a’ to ‘b’.

In one embodiment, when operating in state 320, LAN controller 213 may adjust its retransmission policy to limit the number of retransmissions allowed per packet to ‘N_{a,b,j}’ as determined in either equation (4a) or (4b) (among other possibilities), when using rate ‘rⱼ’ that maximizes the flow-rate ‘F_{a,b,j}’ in equation (2).

It is further recognized that ‘N_{a,b,j}’ may be computed to be a non-integral number when using the method of equation (4a). For example, when operating in state 320, LAN controller 213 may adjust the retransmission policy across multiple packets to meet the constraints posed by a non-integral ‘N_{a,b,j}’ in an average sense.

In one embodiment, when operating in state 320, LAN controller 213 may adjust the retransmission policy across multiple packets to apply the constraint of ‘N_{a,b,j}’ in an average sense. For instance, LAN controller 213 can maintain a count of ‘number of credits’ available for retransmission based on transmission statistics at a given flowrate ‘F_{a,b,j}’. It can then use the available credits to allow for more retransmissions of some frames based on accumulated credits when other frames were transmitted successfully before reaching the retransmission limit ‘N_{a,b,j}’.

In some embodiments, when content source device 210 is ‘deep packet inspection’ capable or by some other means able to prioritize some packets of the data stream generated by content generator 211 over others, LAN controller 213 may also apply the constraint of ‘N_{a,b,j}’ in an average sense, allowing for more retransmissions of high priority packets over others.

Note that the methods described herein may be applied such that content source device 210 may support simultaneous transmission of multiple streams—to either the same destination or to multiple destinations. Depending on how the different streams are prioritized, for example buffer memory 212 may be partitioned among the various streams or all transmissions between ‘a’ and ‘b’ may be treated the same, the methods of the present embodiment may accordingly be applied.

The effective throughput ‘EffT_{a,b,i}’ as transmitted by LAN controller 213 based on rate ‘rᵢ’ selected from the set of rates a′ by the LAN controller according the methods of the present invention, as described above, is hence given by equation (5):

EffT_{a,b,i}=rᵢ*η_{a,b,i}*(1−PER_{a,b,i})*(1−μ) (5)

In some embodiments, thresholds thresh₁₂ 312 and thresh₂₁ 321 may be determined at run-time (e.g., during transmission of data) and may be functions of the size of the buffer memory 212, the output data-rate of the content generator 211 (i.e., the offered load T), and the effective throughput of the LAN controller 213, as described by equation (6), below:

{thresh₁₂,thresh₂₁}=f(nbuffMax,I,EffT_{a,b,i}) (6)

In some embodiments, the computation or adjustment of ‘thresh₁₂’ and ‘thresh₂’ may additionally account for the burstiness of the ingress traffic/offered-load and the egress traffic flow, the expected length of sequence of high priority packets, and/or the response-time of the implementation, among other factors.

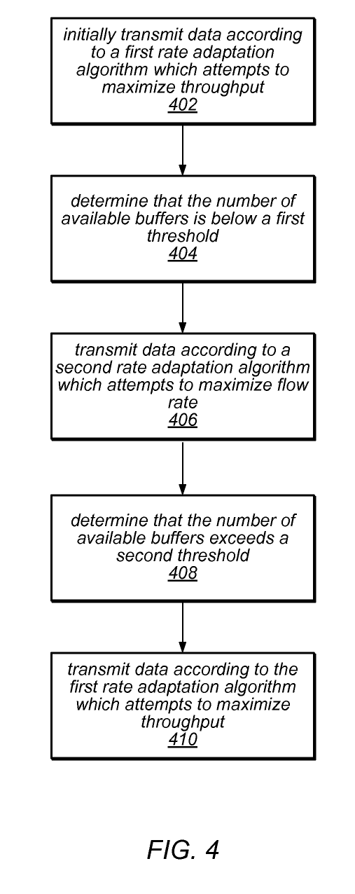

### FIG. 4—Multi-State Rate Adaptation for Distribution of Data

FIG. 4 is a block diagram illustrating one embodiment of a method of multi-state rate adaptation for the distribution of data. More specifically, FIG. 4 describes various embodiments of a method corresponding to the descriptions of FIGS. 2 and 3 above. The method shown in FIG. 4 may be used in conjunction with any of the computer systems, devices, or circuits shown in the above Figures, among other devices. In various embodiments, some of the method elements shown may be performed concurrently, performed in a different order than shown, or omitted. Additional method elements may also be performed as desired. As shown, this method may operate as follows.

In 402, data (e.g., multimedia data, including video data) may be initially transmitted from a first device to a second device using a selected rate adaptation algorithm. However, it should be noted that the method may be extended to transmit from a first device to a plurality of other devices, e.g., in a multicast. The data may be generated or received from a content generator and may be stored in one or more buffers (e.g., a plurality of buffers) for transmission. Note that the data may be generated at a rate that is independent of a rate of transmission from the first device to the second device.

In one embodiment, the initially selected rate adaptation algorithm may be the first algorithm described above. As indicated above, the first rate adaptation algorithm may provide increased throughput, i.e., it may attempt to maximize throughput. Throughput may be defined as:

T_{a,b,i}=rᵢ*η_{a,b,i}*(1−PER_{a,b,i})

where η_{a,b,i} is the efficiency when transmitting from the first device (‘a’) to the second device (‘b’) at rate ‘rᵢ’, and where PER_{a,b,i} is the probability of error (PER) of the channel from ‘a’ to ‘b’ for rate ‘rᵢ’.

In 404, it may be determine that the number of available buffers (or the amount of memory available in the buffers) is below a first threshold.

Based on the determination in 404, in 406, data may be transmitted from the first device to the second device (or a plurality of devices) using a second rate adaptation algorithm (e.g., the second rate adaptation algorithm described above, which attempts to maximize flow rate). Thus, the number of available buffers may be used to determine which rate adaptation algorithm is used. More specifically, in one embodiment, the number of available buffers may be used to determine when to switch from one rate adaptation algorithm to another.

As indicated above, the second rate adaptation algorithm may provide increased flowrate, i.e., it may attempt to maximize flowrate. Flowrate may be defined as:

F_{a,b,j}=rⱼ*η_{a,b,j}*(1−PER_{a,b,j})*N_{a,b,j}

where ‘η_{a,b,j}’ is the efficiency when transmitting from the first device (a) to the second device (‘b’) at rate ‘rⱼ’, where ‘PER_{a,b,j}’ is the probability of error (PER) of the channel from ‘a’ to ‘b’ for rate ‘rⱼ’, and where ‘N_{a,b,j}’ is the maximum number of transmission attempts allowed for the flow from ‘a’ to ‘b’ at rate ‘rⱼ’.

In 408, it may be determined that the number of available buffers exceeds the second threshold, and correspondingly, in 410, the data may be transmitted according to the first rate adaptation algorithm, which attempts to maximize throughput.

Thus, data may be transmitted according to two different rate adaptation algorithms depending on a number of available buffers and/or the amount of remaining memory in the buffers. Note that the changeover from one algorithm to another (or one mode of an algorithm to another) may occur during the transfer of the same data stream. Thus, the changes may occur “on the fly” while transmitting the data. Thus, the determinations and changing of algorithms of 404-410 may occur a plurality of times during transfer of data from the first device to the second device (or the plurality of devices). Additionally, it should be noted that the method may be extended to a plurality of rate adaptation algorithms.

Note that the first and second thresholds may be the same threshold; however, these thresholds may be different, e.g., in order to avoid constant switching between the two algorithms when the number of available buffers is near the threshold. For example, in one embodiment, the first threshold may be higher than the second threshold. Additionally, in some embodiments, the first threshold and/or the second threshold may be dynamically adjusted during run time (e.g., while data is being transferred). Such adjustments may be based on the size of the plurality of buffers, the current output data-rate, and/or an effective transmission rate. Alternatively, or additionally, the adjusting may be performed based on an expected length of sequence of high priority packets of the data and/or burstiness of said transmitting the data.

### Content Renderer

In one embodiment, buffer memory 242 and content renderer 241 may be aware of the characteristics of the underlying MAC and PHY layers adopted by LAN controller 243. Specifically, when LAN Controller 243 uses the ‘strictly ordered’ or the ‘HT immediate block-acknowledgement’ modes of the IEEE 802.11 WLAN as the underlying connectivity layer between content source device 210 and content sink device 240, buffer memory 242 may exploit the knowledge that the received packets from LAN controller 243 are in order. Consequently, the buffer memory (e.g., the controlling device) may not attempt to reorder packets received from 243 before delivery to content renderer 241, thus encountering reduced processing overhead and latency.

Such embodiments may be realized in one of several ways. For instance, the ‘reordering function’ of buffer memory 242 could be disabled by configuration by system controller 247 via control path 249, based on knowledge that underlying connectivity technology of LAN Controller 243 is ordered. Alternately, system controller 247 could determine the nature of the underlying connectivity and configure the buffer memory appropriately via 249.

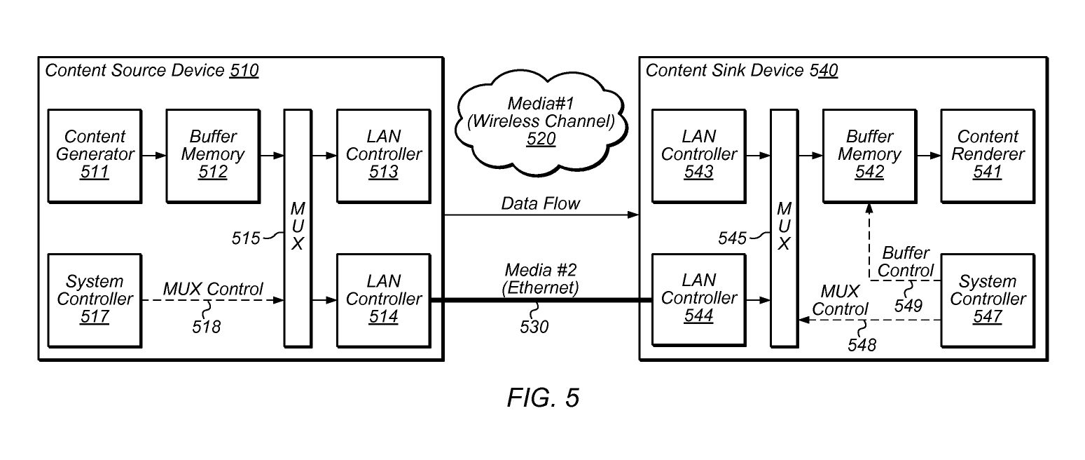

### FIG. 5—Exemplary Operation

FIG. 5 depicts an example realization of an apparatus incorporating the methods described herein in the context of a heterogeneous network in which content source device 510 and content sink device 540 are connected via multiple connectivity interfaces. Note that this Figure and corresponding descriptions are exemplary only and do not limit the above described embodiments. In the example of FIGS. 5, 510 and 540 are connected via a wireless channel 520 and an Ethernet channel 530. 510 and 540 have multiple LAN controllers being able to connect on the various connectivity media. In this example LAN controllers 513 and 543 are used to connect 510 and 540 over the wireless channel 520. Likewise, LAN controllers 514 and 544 are used to connect 510 and 540 over the Ethernet channel.

At the content source device 510, content generator 511 may feed data to a buffer memory 512. Multiplexor 515 may control the flow of data from 512 to the respective LAN controller 513 or 514. Among other functions, system controller 517 may configure multiplexor 515 to select between LAN controllers 513 and 514, via control path 518.

Likewise at the content sink device 540, there may be multiple LAN controllers —543 and 544 corresponding to the wireless and power-line media in this example. These may interface to buffer memory 542 via multiplexor 515 and eventually to content renderer 541. Among other functions, system controller 547 may configure multiplexor 545 to select between LAN controllers 543 and 544, via control path 548.

In one embodiment, content source device 510 may establish a communication with content sink device 540 using either LAN controller 513 or 514 over medium 520 or 530, respectively, as determined by pre-configuration, user input, or negotiation between system controllers 517 and 547, among other means. System controller 547 may be aware of the underlying MAC controller in use by the content sink device 540 and may configure buffer memory 542 accordingly to selectively implement the reordering function.

The present example may be modified in the context of a single connectivity technology between content source device 510 and content sink device 540, both of which implement a single LAN controller as depicted in FIG. 2.

Additionally, there may be a single LAN controller the can implement a plurality of LAN technologies and the mode of operation may be determined depending on connectivity, e.g., in real time. Additionally, the system controller of such a device may configure the buffer memory appropriately depending on the adopted mode of connection.

In one embodiment, system controller 547 may be involved in the signaling between content source device 510 and content sink device 540 and may be configured to detect the signaling associated with the start of streaming. For example, system controller 547 may be responsible for generating/being able to detect the Internet group multicast protocol (IGMP) or digital living media alliance (DLNA) or other protocols used for the initiation/control of audio/video content over a network. Following stream initiation, system controller 547 may configure buffer-memory 542 via signal path 549 to wait for filling to a predetermined level before starting playback to content renderer 541. For example, this preset value may be 50% of the depth of buffer memory 542 to compensate for both positive and negative jitter.

On detecting the resumption of a stream from an empty buffer state, such as when there is a channel outage or any other anomaly, e.g., resulting in an under-run of buffer memory 542, system controller 547 may configure buffer memory 542 via signal path 549, to make packets available to content renderer 541 immediately after they are received by buffer memory. In one embodiment, this may be achieved by dynamically configuring the preset value to 0%. Thus, recognizing that after recovery from a channel outage event, the content source device 510 would always have packets to send to the content sink device 540 by virtue of its buffer 512 being full, the probability of packet loss due to overflow of buffer memory 542 is minimized by attempting to clear the contents of the buffer as they are received.

Note that embodiments described above may be equally applicable in the context of the apparatus of FIG. 2 (or any of the above described embodiments), where content source device 210 and content sink device 240 are connected by a single connectivity technology, operating over medium 220. In such a realization, system controller 247 can control the buffer threshold at which buffer memory 242 makes packets available to content renderer 241, via signal path 249.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for transmitting data, comprising:
transmitting data from a first device to a second device using a selected rate adaptation algorithm, wherein said transmitting data utilizes a plurality of buffers, and wherein the selected rate adaptation algorithm is one of a first rate adaptation algorithm or a second rate adaptation algorithm;
determining that a number of available buffers of the plurality of buffers is below a first threshold when transmitting using the first algorithm;
wherein said transmitting is performed using the second rate adaptation algorithm in response to said determining that the number of available buffers of the plurality of buffers is below the first threshold, wherein the second rate adaptation algorithm provides increased flowrate;
determining that the number of available buffers of the plurality of buffers exceeds a second threshold when transmitting using the second algorithm; and
wherein said transmitting is performed using the first rate adaptation algorithm in response to said determining that the number of available buffers of the plurality of buffers exceeds the second threshold, wherein the first rate adaptation algorithm provides increased throughput.

2. The method of claim 1, further comprising:
dynamically adjusting the first threshold and the second threshold during run time.

3. The method of claim 2, where said adjusting is performed based on a size of the plurality of buffers, a current offered load, and/or an effective transmission rate.

4. The method of claim 2, wherein said adjusting is performed based on an expected length of sequence of high priority packets of the data and/or burstiness of said transmitting the data.

5. The method of claim 1, wherein throughput is defined as:
T_{a,b,i}=rᵢ*η_{a,b,i}*(1−PER_{a,b,i})
wherein η_{a,b,i} is the efficiency when transmitting from the first device (‘a’) to the second device (‘b’) at rate ‘rⱼ’, and wherein PER_{a,b,i} is the probability of error (PER) of the channel from ‘a’ to ‘b’ for rate ‘rᵢ’.

6. The method of claim 1, wherein flowrate is defined as:
F_{a,b,j}=rⱼ*η_{a,b,j}*(1−PER_{a,b,j})*N_{a,b,j}
wherein ‘η_{a,b,j}’ is the efficiency when transmitting from the first device (‘a’) to the second device (‘b’) at rate ‘rⱼ’, wherein ‘PER_{a,b,j}’ is the probability of error (PER) of the channel from ‘a’ to ‘b’ for rate ‘rⱼ’, and wherein ‘N_{a,b,j}’ is the maximum number of transmission attempts allowed for the flow from ‘a’ to ‘b’ at rate ‘rⱼ’.

7. The method of claim 6, wherein N_{a,b,j} is calculated according to:
N_{a,b,j}=[rⱼ*η_{a,b,j}*(1−μ)]/I
wherein ‘μ’ is the medium utilization for transmissions on a channel other than from ‘a’ to ‘b’.

8. The method of claim 6, wherein N_{a,b,j} is calculated according to:
N_{a,b,j}=floor([rⱼ*η_{a,b,j}*(1−μ)]/I)
wherein ‘μ’ is the medium utilization for transmissions on a channel other than from ‘a’ to ‘b’.

9. The method of claim 6, wherein N_{a,b,j} is applied in an average sense across multiple packets.

10. The method of claim 6, wherein N_{a,b,j} is applied in an average sense, allowing for more retransmission of higher priority packets over others.

11. The method of claim 1, wherein said transmitting is also performed to a third device and wherein the data comprises video data.

12. The method of claim 1, wherein the data is generated at a rate that is independent of a rate of transmission from the first device to the second device.

13. A system for transmitting data to one or more devices, comprising:
a content generator, wherein the content generator generates data for transmission to the one or more devices at a first rate;
a plurality of buffers coupled to the content generator, wherein the plurality of buffers buffer the data generated by the content generator;
a transmitter, wherein the transmitter transmits the data stored in the plurality of buffers at a second rate, wherein the second rate varies over time and is independent of the first rate;
wherein the transmitter transmits the data according to a first rate adaptation algorithm or a second rate adaptation algorithm based on a number of available buffers, wherein the second rate adaptation algorithm is used when the number of available buffers is below a first threshold, wherein the second rate adaptation algorithm increases flowrate, wherein the first rate adaptation algorithm is used when the number of available buffers of the plurality of buffers exceeds a second threshold, and wherein the first rate adaptation algorithm increases throughput.

14. The system of claim 13, wherein the first threshold and the second threshold are dynamically adjusted during run time.

15. The system of claim 14, where the first threshold and the second threshold are adjusted based on a size of the plurality of buffers, a current output data-rate, and/or an effective transmission rate.

16. The system of claim 14, where the first threshold and the second threshold are adjusted based on an expected length of sequence of high priority packets of the data and/or burstiness of said transmitting the data.

17. The system of claim 13, wherein throughput is defined as:
T_{a,b,i}=rᵢ*η_{a,b,i}*(1−PER_{a,b,i})
wherein η_{a,b,i} is the efficiency when transmitting from the first device (‘a’) to the second device (‘b’) at rate ‘rᵢ’, and wherein PER_{a,b,i} is the probability of error (PER) of the channel from ‘a’ to ‘b’ for rate ‘rᵢ’.

18. The system of claim 13, wherein flowrate is defined as:
F_{a,b,j}=rⱼ*η_{a,b,j}*(1−PER_{a,b,j})*N_{a,b,j}
wherein ‘η_{a,b,j}’ is the efficiency when transmitting from the first device (‘a’) to the second device (‘b’) at rate ‘rⱼ’, wherein ‘PER_{a,b,j}’ is the probability of error (PER) of the channel from ‘a’ to ‘b’ for rate ‘rⱼ’, and wherein ‘N_{a,b,j}’ is the maximum number of transmission attempts allowed for the flow from ‘a’ to ‘b’ at rate ‘rⱼ’.

19. The system of claim 13, wherein the one or more devices comprise a plurality of devices and wherein the data comprises video data.

20. A memory medium comprising program instructions for configuring transmission of data, wherein the transmission of data uses a plurality of buffers, wherein the program instructions are executable by a processor to:
configure the transmission according to a first rate adaptation algorithm, wherein the first rate adaptation algorithm provides increased throughput;
determine that a number of available buffers of the plurality of buffers is below a first threshold;
configure the transmission according to a second rate adaptation algorithm in response to a determination that the number of available buffers of the plurality of buffers is below the first threshold, wherein the second rate adaptation algorithm provides increased flowrate;
determine that the number of available buffers of the plurality of buffers exceeds a second threshold; and
configure the transmission according to the first rate adaptation algorithm in response to a determination that the number of available buffers of the plurality of buffers exceeds the second threshold.

21. The memory medium of claim 20, wherein the program instructions are further executable to:
dynamically adjust the first threshold and the second threshold during run time.

22. The memory medium of claim 20, wherein throughput is defined as:
T_{a,b,i}=rᵢ*η_{a,b,i}*(1−PER_{a,b,i})
wherein η_{a,b,i} is the efficiency when transmitting from the first device (‘a’) to the second device (‘b’) at rate ‘rᵢ’, and wherein PER_{a,b,i} is the probability of error (PER) of the channel from ‘a’ to ‘b’ for rate ‘rᵢ’.

23. The memory medium of claim 20, wherein flowrate is defined as:
F_{a,b,j}=rⱼ*η_{a,b,j}*(1−PER_{a,b,j})*N_{a,b,j}
wherein ‘η_{a,b,j}’ is the efficiency when transmitting from the first device (‘a’) to the second device (‘b’) at rate ‘rⱼ’, wherein ‘PER_{a,b,j}’ is the probability of error (PER) of the channel from ‘a’ to ‘b’ for rate ‘rⱼ’, and wherein ‘N_{a,b,j}’ is the maximum number of transmission attempts allowed for the flow from ‘a’ to ‘b’ at rate ‘rⱼ’.

24. The memory medium of claim 20, wherein the data is generated at a rate that is independent of a rate of transmission from the first device to the second device.
